(19) United States
(12) Patent Application Publication
(10) Pub. No.: US 2020/0128528 A1
(43) Pub. Date: Apr. 23, 2020

(54) WIRELESS COMMUNICATION METHOD AND DEVICE

(71) Applicant: GUANGDONG OPPO MOBILE TELECOMMUNICATIONS CORP., LTD., Dongguan, Guangdong (CN)

(72) Inventor: Hai TANG, Dongguan, Guangdong (CN)

(73) Assignee: GUANGDONG OPPO MOBILE TELECOMMUNICATIONS CORP., LTD., Dongguan, Guangdong (CN)

(21) Appl. No.: 16/626,474

(22) PCT Filed: Sep. 29, 2017
(86) PCT No.: PCT/CN2017/104577

§ 371 Date: Dec. 24, 2019

(51) Int. Cl. H04W 72/04; H04L 5/00; H04L 1/16; H04L 27/26

(52) U.S. Cl. CPC H04W 72/048; H04W 72/0493; H04L 27/2607; H04L 5/0092; H04L 1/1642; H04W 72/0453

(57) ABSTRACT

Provided in the embodiments of the present application are a wireless communication method and device, capable of improving communication performance in the aspect of use of configuration resources. The method comprises: receiving by a first device first information sent by a second device, the first information being used to configure a first resource set to the first device; determining, on the basis of the first resource set, by the first device a first resource for transmitting a first channel which is between the first device and the second device; and determining, on the basis of the first resource set, by the first device a second resource for transmitting a second channel which is between the first device and the second device.

### TECHNICAL FIELD

The disclosure relates to the field of communications, and more particularly to a method and device for wireless communication.

### BACKGROUND

In a Long Term Evolution (LTE) system, a network side may configure a common search space and a user-specific search space for a terminal, and the terminal may search for, in the common search space and the user-specific search space, a Physical Downlink Control Channel (PDCCH) transmitted by the network side. For a channel such as a Physical Uplink Shared Channel (PUSCH), a Physical Uplink Control Channel (PUCCH) or a Physical Downlink Shared Channel (PDSCH), a network device may perform resource scheduling on the terminal to implement data transmission with the terminal.

In a 5th-Generation (5G) system, the requirement on communication performance is high, and configuration and usage of resources are more flexible.

Therefore, how to improve communication performance in the usage of configuration resources is an urgent problem to be solved.

### SUMMARY

Embodiments of the disclosure provide a method and device for wireless communication, which may improve communication performance in the usage of configuration resources.

In a first aspect, there is provided a method for wireless communication, which may include the following operations.

A first device receives first information transmitted by a second device, here, the first information is used in configuring a first resource set for the first device.

The first device determines, based on the first resource set, a first resource for transmission of a first channel between the first device and the second device.

The first device determines, based on the first resource set, a second resource for transmission of a second channel between the first device and the second device.

Accordingly, in the embodiments of the disclosure, the second device configures the first resource set for the first device, the first device may perform transmission of the first channel based on the first resource set, and the first device may also perform transmission of the second channel based on a second resource set. Therefore, the problem of high signaling overhead caused by the case where the first device separately configures, for the second device, a resource set for the first channel and a resource set for the second channel may be solved, flexibility in the configuration and use of the resources may be achieved, and an association between transmission of the first channel and transmission of the second channel may be achieved.

In combination with the first aspect, in a possible implementation mode of the first aspect, the first channel may be different from the second channel in terms of at least one of: a bandwidth part where the channel is located, a carrier where the channel is located, a cell where the channel is located, a duplex direction adopted for the channel, or a numerology adopted for the channel.

In combination with the first aspect or any abovementioned possible implementation mode, in another possible implementation mode of the first aspect, the numerology adopted for the first channel is different from the numerology adopted for the second channel may include at least one of the following: a subcarrier spacing adopted for the first channel is different from a subcarrier spacing adopted for the second channel, or a cyclic prefix adopted for the first channel is different from a cyclic prefix adopted for the second channel.

In combination with the first aspect or any abovementioned possible implementation mode, in another possible implementation mode of the first aspect, the first channel and the second channel may be a same type of channel.

In combination with the first aspect or any above mentioned possible implementation mode, in another possible implementation mode of the first aspect, the operation that the first device determines, based on the first resource set, the second resource for the transmission of the second channel between the first device and the second device may include the following operations.

The first device determines a second resource set based on the first resource set.

The first device determines, from the second resource set, the second resource for the transmission of the second channel between the first device and the second device.

In combination with the first aspect or any abovementioned possible implementation mode, in another possible implementation mode of the first aspect, the method may further include the following operation.

The first device receives second information transmitted by the second device.

The operation that the first device determines, from the second resource set, the second resource for the transmission of the second channel between the first channel and the second device may include the following operation.

The second resource is determined from the second resource set according to the second information.

In combination with the first aspect or any abovementioned possible implementation mode, in another possible implementation mode of the first aspect, the operation that the first device determines the second resource set based on the first resource set may include the following operation.

The second resource set is determined based on the first resource set in one of the following manners that: a subset of the first resource set is determined as the second resource set; a resource is added into the first resource set to form the second resource set; a number of resources in the first resource set or a granularity of resources in the first resource set is extended or reduced in at least one of a time domain or a frequency domain to form the second resource set; or the first resource set is offset in a time domain or a frequency domain to form the second resource set.

In combination with the first aspect or any abovementioned possible implementation mode, in another possible implementation mode of the first aspect, the manner in which the second resource set is determined based on the first resource set includes that the subset of the first resource set is determined as the second resource set, and the method may further include the following operation.

The first device receives third information from the second device, here, the third information is used to indicate the subset.

In combination with the first aspect or any abovementioned possible implementation mode, in another possible implementation mode of the first aspect, the manner in which the second resource set is determined based on the first resource set includes that the resource is added into the first resource set to form the second resource set, and the method further includes the following operation.

The first device receives fourth information from the second device, here, the fourth information is used to indicate a resource to be added.

In combination with the first aspect or any abovementioned possible implementation mode, in another possible implementation mode of the first aspect, the manner in which the second resource set is determined based on the first resource set includes that the number of resources in the first resource set or the granularity of resources in the first resource set is extended or reduced in the at least one of the time domain or the frequency domain to form the second resource set, and the method may further include the following operation.

The first device receives fifth information from the second device, here, the fifth information is used to indicate an amplitude of extension or reduction.

In combination with the first aspect or any abovementioned possible implementation mode, in another possible implementation mode of the first aspect, the manner in which the second resource set is determined based on the first resource set includes that the number of resources in the first resource set or a granularity of resources in the first resource set is extended or reduced in the at least one of the time domain or the frequency domain to form the second resource set, and the method may further include the following operation.

An amplitude of extension or reduction is determined based on a frequency-domain magnitude relationship between a carrier where the first channel is located and a carrier where the second channel is located or based on a frequency-domain magnitude relationship between a bandwidth part where the first channel is located and a bandwidth part where the second channel is located.

In combination with the first aspect or any abovementioned possible implementation mode, in another possible implementation mode of the first aspect, the manner in which the second resource set is determined based on the first resource set includes that the first resource set is offset in the time domain or the frequency domain to form the second resource set, and the method may further include the following operation.

The first device receives sixth information from the second device, here, the sixth information is used to indicate an offset.

In combination with the first aspect or any abovementioned possible implementation mode, in another possible implementation mode of the first aspect, the manner in which the second resource set is determined based on the first resource set may be preset in the first device.

In combination with the first aspect or any abovementioned possible implementation mode, in another possible implementation mode of the first aspect, the operation that the first device determines, based on the first resource set, the first resource for the transmission of the first channel between the first device and the second device may include the following operation.

The first device determines, from the first resource set, the first resource for the transmission of the first channel.

In combination with the first aspect or any abovementioned possible implementation mode, in another possible implementation mode of the first aspect, the method may further include the following operation.

The first device receives seventh information transmitted by the second device.

The operation that the first device determines, from the first resource set, the first resource for the transmission of the first channel may include the following operation.

The first device determines the first resource from the first resource set according to the seventh information.

In combination with the first aspect or any abovementioned possible implementation mode, in another possible implementation mode of the first aspect, the operation that the first device determines, based on the first resource set, the first resource for the transmission of the first channel between the first device and the second device may include the following operations.

The first device determines a third resource set based on the first resource set.

The first device determines, from the third resource set, the first resource for the transmission of the first channel between the first device and the second device.

In combination with the first aspect or any abovementioned possible implementation mode, in another possible implementation mode of the first aspect, the method may further include the following operation.

The first device receives eighth information transmitted by the second device.

The operation that the first device determines, from the third resource set, the first resource for the transmission of the first channel between the first device and the second device may include the following operation.

The first resource is determined from the third resource set according to the eighth information.

In combination with the first aspect or any abovementioned possible implementation mode, in another possible implementation mode of the first aspect, the operation that the terminal determines the third resource set based on the first resource set may include the following operation.

The third resource set is determined based on the first resource set in one of the following manners that: a subset of the first resource set is determined as the third resource set; a resource is added into the first resource set to form the third resource set; a number of resources in the first resource set or a granularity of resources in the first resource set is extended or reduced in at least one of a time domain or a frequency domain to form the third resource set; or the first resource set is offset in a time domain or a frequency domain to form the third resource set.

In combination with the first aspect or any abovementioned possible implementation mode, in another possible implementation mode of the first aspect, the manner in which the third resource set is determined based on the first resource set includes that the subset of the first resource set is determined as the third resource set, and the method may further include the following operation.

The first device receives ninth information from the second device, here, the ninth information is used to indicate the subset.

In combination with the first aspect or any abovementioned possible implementation mode, in another possible implementation mode of the first aspect, the manner in which the third resource set is determined based on the first resource set includes that the resource is added into the first resource set to form the third resource set, and the method may further include the following operation.

The first device receives tenth information from the second device, here, the tenth information is used to indicate a resource to be added.

In combination with the first aspect or any abovementioned possible implementation mode, in another possible implementation mode of the first aspect, the manner in which the third resource set is determined based on the first resource set includes that the number of resources in the first resource set or the granularity of resources in the first resource set is expanded or contracted in the at least one of the time domain or the frequency domain to form the third resource set, and the method may further include the following operation.

The first device receives eleventh information from the second device, here, the eleventh information is used to indicate an amplitude of extension or reduction.

In combination with the first aspect or any abovementioned possible implementation mode, in another possible implementation mode of the first aspect, the manner in which the third resource set is determined based on the first resource set includes that the number of resources in the first resource set or the granularity of resources in the first resource set is extended or reduced in the at least one of the time domain or the frequency domain to form the third resource set, and the method may further include the following operation.

An amplitude of extension or reduction is determined based on a frequency-domain magnitude relationship between a carrier where the first channel is located and a carrier where the second channel is located or based on a frequency-domain magnitude relationship between a bandwidth part where the first channel is located and a bandwidth part where the second channel is located.

In combination with the first aspect or any abovementioned possible implementation mode, in another possible implementation mode of the first aspect, the manner in which the third resource set is determined based on the first resource set includes that the first resource set is offset in the time domain or the frequency domain to form the third resource set, and the method may further include the following operation.

The first device receives twelfth information from the second device, here, the twelfth information is used to indicate an offset.

In combination with the first aspect or any abovementioned possible implementation mode, in another possible implementation mode of the first aspect, the manner in which the third resource set is determined based on the first resource set may be preset in the first device.

In combination with the first aspect or any abovementioned possible implementation mode, in another possible implementation mode of the first aspect, the first device may be a terminal device, and the second device may be a base station device.

In a second aspect, there is provided a method for wireless communication, which may include the following operations.

A second device transmits first information to a first device, here, the first information is used in configuring a first resource set for the first device.

The second device determines, based on the first resource set, a first resource for transmission of a first channel between the second device and the first device.

The second device determines, based on the first resource set, a second resource for transmission of a second channel between the second device and the first device.

Accordingly, in the embodiments of the disclosure, the second device configures the first resource set for the first device, the first device may transmit the first channel based on the first resource set, and the first device may also transmit the second channel based on a second resource set. Therefore, the problem of high signaling overhead caused by the case where the first device separately configures, for the second device, a resource set for the first channel and a resource set for the second channel may be solved, flexibility in configuration and use of resources may be achieved, and an association between the transmission of the first channel and the transmission of the second channel may be achieved.

In combination with the second aspect, in a possible implementation mode of the second aspect, the first channel may be different from the second channel in terms of at least one of: a bandwidth part where the channel is located, a carrier where the channel is located, a cell where the channel is located, a duplex direction adopted for the channel, or a numerology adopted for the channel.

In combination with the second aspect or any abovementioned possible implementation mode, in another possible implementation mode of the second aspect, that the numerology adopted for the first channel is different from the numerology adopted for the second channel may include at least one of the following: a subcarrier spacing adopted for the first channel is different from a subcarrier spacing adopted for the second channel, or a cyclic prefix adopted for the first channel is different from a cyclic prefix adopted for the second channel.

In combination with the second aspect or any abovementioned possible implementation mode, in another possible implementation mode of the second aspect, the first channel and the second channel may be a same type of channel.

In combination with the second aspect or any abovementioned possible implementation mode, in another possible implementation mode of the second aspect, the operation that the second device determines, based on the first resource set, the second resource for the transmission of the second channel between the second device and the first device may include the following operations.

The second device determines a second resource set based on the first resource set.

The second device determines, from the second resource set, the second resource for the transmission of the second channel between the second device and the first device.

In combination with the second aspect or any abovementioned possible implementation mode, in another possible implementation mode of the second aspect, the method may further include the following operation.

The second device transmits second information to the first device for the first device to determine the first resource from the first resource set.

In combination with the second aspect or any abovementioned possible implementation mode, in another possible implementation mode of the second aspect, the operation that the second device determines the second resource set based on the first resource set may include the following operation.

The second resource set is determined based on the first resource set in one of the following manners that: a subset of the first resource set is determined as the second resource set; a resource is added into the first resource set to form the second resource set; a number of resources in the first resource set or a granularity of resources in the first resource set is extended or reduced in at least one of a time domain or a frequency domain to form the second resource set; or the first resource set is offset in a time domain or a frequency domain to form the second resource set.

In combination with the second aspect or any abovementioned possible implementation mode, in another possible implementation mode of the second aspect, the manner in which the second resource set is determined based on the first resource set includes that the subset of the first resource set is determined as the second resource set, and the method may further include the following operation.

The second device transmits third information to the first device, here, the third information is used to indicate the subset.

In combination with the second aspect or any abovementioned possible implementation mode, in another possible implementation mode of the second aspect, the manner in which the second resource set is determined based on the first resource set includes that the resource is added into the first resource set to form the second resource set, and the method may further include the following operation.

The second device transmits fourth information to the first device, here, the fourth information is used to indicate a resource to be added.

In combination with the second aspect or any abovementioned possible implementation mode, in another possible implementation mode of the second aspect, the manner in which the second resource set is determined based on the first resource set includes that the number of resources in the first resource set or the granularity of resources in the first resource set is extended or reduced in the at least one of the time domain or the frequency domain to form the second resource set, and the method may further include the following operation.

The second device transmits fifth information to the first device, here, the fifth information is used to indicate an amplitude of extension or reduction.

In combination with the second aspect or any abovementioned possible implementation mode, in another possible implementation mode of the second aspect, the manner in which the second resource set is determined based on the first resource set includes that the number of resources in the first resource set or the granularity of resources in the first resource set is extended or reduced in the at least one of the time domain or the frequency domain to form the second resource set, and the method may further include the following operation.

An amplitude of extension or reduction is determined based on a frequency-domain magnitude relationship between a carrier where the first channel is located and a carrier where the second channel is located or based on a frequency-domain magnitude relationship between a bandwidth part where the first channel is located and a bandwidth part where the second channel is located.

In combination with the second aspect or any abovementioned possible implementation mode, in another possible implementation mode of the second aspect, the manner in which the second resource set is determined based on the first resource set includes that the first resource set is offset in the time domain or the frequency domain to form the second resource set, and the method may further include the following operation.

The second device transmits sixth information to the first device, here, the sixth information is used to indicate an offset.

In combination with the second aspect or any abovementioned possible implementation mode, in another possible implementation mode of the second aspect, the operation that the second device determines, based on the first resource set, the first resource for the transmission of the first channel between the second device and the first device may include the following operation.

The second device determines, from the first resource set, the first resource for the transmission of the first channel.

In combination with the second aspect or any abovementioned possible implementation mode, in another possible implementation mode of the second aspect, the method may further include the following operation.

The second device transmits seventh information to the first device for the first device to determine the first resource from the first resource set.

In combination with the second aspect or any abovementioned possible implementation mode, in another possible implementation mode of the second aspect, the operation that the second device determines, based on the first resource set, the first resource for the transmission of the first channel between the second device and the first device may include the following operations.

The second device determines a third resource set based on the first resource set.

The second device determines, from the third resource set, the first resource for the transmission of the first channel between the second device and the first device.

In combination with the second aspect or any abovementioned possible implementation mode, in another possible implementation mode of the second aspect, the method may further include the following operation.

The second device transmits eighth information to the first device for the first device to determine the first resource from the third resource set.

In combination with the second aspect or any abovementioned possible implementation mode, in another possible implementation mode of the second aspect, the operation that the second device determines the third resource set based on the first resource set may include the following operation.

The third resource set is determined based on the first resource set in one of the following manners that: a subset of the first resource set is determined as the third resource set; a resource is added into the first resource set to form the third resource set; a number of resources in the first resource set or a granularity of resources in the first resource set is extended or reduced in at least one of a time domain or a frequency domain to form the third resource set; or the first resource set is offset in a time domain or a frequency domain to form the third resource set.

In combination with the second aspect or any abovementioned possible implementation mode, in another possible implementation mode of the second aspect, the manner in which the third resource set is determined based on the first resource set includes that the subset of the first resource set is determined as the third resource set, and the method may further include the following operation.

The second device transmits ninth information to the first device, here, the ninth information is used to indicate the subset.

In combination with the second aspect or any abovementioned possible implementation mode, in another possible implementation mode of the second aspect, the manner in which the third resource set is determined based on the first resource set includes that the resource is added into the first resource set to form the third resource set, and the method may further include the following operation.

The second device transmits tenth information to the first device, here, the tenth information is used to indicate a resource to be added.

In combination with the second aspect or any abovementioned possible implementation mode, in another possible implementation mode of the second aspect, the manner in which the third resource set is determined based on the first resource set includes that the number of resources in the first resource set or the granularity of resources in the first resource set is extended or reduced in the at least one of the time domain or the frequency domain to form the third resource set, and the method may further include the following operation.

The second device transmits eleventh information to the first device, here, the eleventh information is used to indicate an amplitude of extension or reduction.

In combination with the second aspect or any abovementioned possible implementation mode, in another possible implementation mode of the second aspect, the manner in which the third resource set is determined based on the first resource set includes that the number of resources in the first resource set or the granularity of resources in the first resource set is extended or reduced in the at least one of the time domain or the frequency domain to form the third resource set, and the method may further include the following operation.

An amplitude of extension or reduction is determined based on a frequency-domain magnitude relationship between a carrier where the first channel is located and a carrier where the second channel is located or based on a frequency-domain magnitude relationship between a bandwidth part where the first channel is located and a bandwidth part where the second channel is located.

In combination with the second aspect or any abovementioned possible implementation mode, in another possible implementation mode of the second aspect, the manner in which the third resource set is determined based on the first resource set includes that the first resource set is offset in the time domain or the frequency domain to form the third resource set, and the method may further include the following operation.

The second device transmits twelfth information to the first device, here, the twelfth information is used to indicate an offset.

In a third aspect, there is provided a device for wireless communication, which is configured to execute the method in the first aspect or any possible implementation mode of the first aspect. The device for wireless communication includes functional modules configured to execute the method in the first aspect or any possible implementation mode of the first aspect.

In a fourth aspect, there is provided a device for wireless communication, which is configured to execute the method in the second aspect or any possible implementation mode of the second aspect. The device for wireless communication includes functional modules configured to execute the method in the second aspect or any possible implementation mode of the second aspect.

In a fifth aspect, there is provided a device for wireless communication, which includes a processor, a memory and a transceiver. The processor, the memory and the transceiver communicate with one another through an internal connection path to transmit or receive at least one of control signals or data signals to enable the device for wireless communication to execute the method in the first aspect or any possible implementation mode of the first aspect.

In a sixth aspect, there is provided a device for wireless communication, which includes a processor, a memory and a transceiver. The processor, the memory and the transceiver communicate with one another through an internal connection path to transmit or receive at least one of control signals or data signals to enable the device for wireless communication to execute the method in the second aspect or any possible implementation mode of the second aspect.

In a seventh aspect, there is provided a computer-readable medium, which is configured to store a computer program, the computer program includes an instruction configured to execute the method in each aspect or any possible implementation mode.

In an eighth aspect, there is provided a computer program product including instructions, which is run on a computer to enable the computer to execute the method in each aspect or any possible implementation mode.

### BRIEF DESCRIPTION OF DRAWINGS

In order to describe the technical solutions of the embodiments of the disclosure more clearly, the drawings used in descriptions about the embodiments or a related art will be simply introduced below. It is apparent that the drawings described below are only some embodiments of the disclosure. Other drawings may further be obtained by those of ordinary skill in the art according to these drawings without creative work.

FIG. 1 is a diagram of a system for wireless communication according to an embodiment of the disclosure.

FIG. 2 is a flowchart of a method for wireless communication according to an embodiment of the disclosure.

FIG. 3 is a flowchart of a method for wireless communication according to an embodiment of the disclosure.

FIG. 4 is a block diagram of a device for wireless communication according to an embodiment of the disclosure.

FIG. 5 is a block diagram of a device for wireless communication according to an embodiment of the disclosure.

FIG. 6 is a block diagram of a system chip according to an embodiment of the disclosure.

FIG. 7 is a block diagram of a communication device according to an embodiment of the disclosure.

### DETAILED DESCRIPTION

The technical solutions in the embodiments of the disclosure will be described below in combination with the drawings in the embodiments of the disclosure. It is apparent that the described embodiments are not all embodiments but part of embodiments of the disclosure. All other embodiments obtained by those of ordinary skill in the art based on the embodiments in the disclosure without creative work shall fall within the scope of protection of the disclosure.

The technical solutions of the embodiments of the disclosure may be applied to various communication systems, for example, a Global System of Mobile Communication (GSM), a Code Division Multiple Access (CDMA) system, a Wideband Code Division Multiple Access (WCDMA) system, a General Packet Radio Service (GPRS), an LTE system, an LTE Frequency Division Duplex (FDD) system, LTE Time Division Duplex (TDD) system, a Universal Mobile Telecommunication System (UMTS), a Worldwide Interoperability for Microwave Access (WiMAX) communication system or a future 5G system.

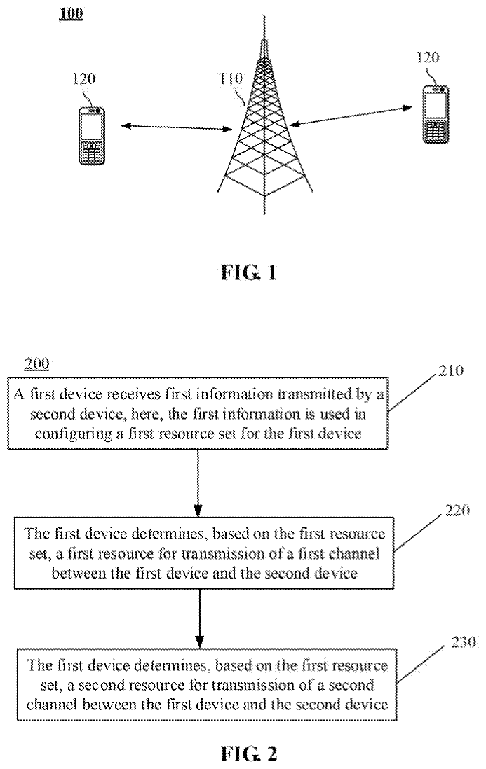

FIG. 1 illustrates a system 100 for wireless communication to which the embodiments of the disclosure are applied. The system 100 for wireless communication may include a network device 110. The network device 100 may be a device which communicates with a terminal device. The network device 100 may provide communication coverage for a specific geographical region and may communicate with a terminal device (for example, User Equipment (UE)) in the coverage. The network device 100) may be a Base Transceiver Station (BTS) in the GSM or the CDMA system, a NodeB (NB) in the WCDMA system, an Evolutional Node B (eNB or eNodeB) in the LTE system or a wireless controller in a Cloud Radio Access Network (CRAN). Or the network device may be a relay station, an access point, a vehicle-mounted device, a wearable device, a network-side device in a future 5G network, a network device in a future evolved Public Land Mobile Network (PLMN) or the like.

The system 100 for wireless communication further includes at least one terminal device 120 within the coverage of the network device 110. The terminal device 120 may be mobile or fixed. The terminal device 120 may be an access terminal, UE, a user unit, a user station, a mobile station, a mobile radio station, a remote station, a remote terminal, a mobile device, a user terminal, a terminal, a wireless communication device, a user agent or a user device. The access terminal may be a cell phone, a cordless phone, a Session Initiation Protocol (SIP) phone, a Wireless Local Loop (WLL) station, a Personal Digital Assistant (PDA), a handheld device with a wireless communication function, a computing device, other processing devices connected to a wireless modem, a vehicle-mounted device, a wearable device, a terminal device in the future 5G network, a terminal device in the future evolved PLMN or the like.

In an embodiment, Device to Device (D2D) communication may be performed between the terminal devices 120.

In an embodiment, the 5G system or network may also be called a New Radio (NR) system or network.

One network device and two terminal devices are exemplarily illustrated in FIG. 1. The system 100 for wireless communication may include multiple network devices and another number of terminal devices may be included in coverage of each network device. There are no limits made thereto in the embodiments of the disclosure.

In an embodiment, the system 100 for wireless communication may further include other network entities such as a network controller and a mobility management entity. There are no limits made thereto in the embodiments of the disclosure.

Terms “system” and “network” in the disclosure may usually be exchanged in the disclosure. In the disclosure, term “and/or” is only an association relationship describing associated objects and represents that three relationships may exist. For example, A and/or B may represent three conditions. That is, independent existence of A, existence of both A and B and independent existence of B. In addition, character “/” in the disclosure usually represents that previous and next associated objects form an “or” relationship.

FIG. 2 is a flowchart of a method 200 for wireless communication according to an embodiment of the disclosure. The method 200 includes at least part of contents in the following contents.

In 210, a first device receives first information transmitted by a second device, here, the first information is used in configuring a first resource set for the first device.

In 220, the first device determines, based on the first resource set, a first resource for transmission of a first channel between the first device and the second device.

In an embodiment, the information transmitted by the second device to the first device may be carried in Radio Resource Control (RRC) signaling, control information, system information or a Media Access Control Control Element (MAC CE).

The first device may select, from the first resource set, a resource as the first resource for the transmission of the first channel. Or the first device may obtain another resource set based on the resource set and select, from another resource set, a resource as the first resource for the transmission of the first channel.

In 230, the first device determines, based on the first resource set, a second resource for transmission of a second channel between the first device and the second device.

The first device may select, from the first resource set, a resource as the second resource for the transmission of the second channel. Or the first device may obtain another resource set based on the resource set and select, from another resource set, a resource as the second resource for the transmission of the second channel.

Here, when the first device selects, from the first resource set, the first resource for the transmission of the first channel, the first device may determine a second resource set based on the first resource set and determine, from the second resource set, the second resource for the transmission of the second channel. In such case, the first resource set may be called a resource set which is configured by the second device for the first device and which is for the first channel.

Or the first device determines a third resource set based on the first resource set and determines, from the third resource set, the first resource for the transmission of the first channel, and the first device determines the second resource set based on the first resource set and determines, from the second resource set, the second resource for the transmission of the second channel.

The resource set mentioned in the embodiment of the disclosure may include at least one of: a time-domain resource, a frequency-domain resource, a space-domain resource, or a code-domain resource.

The resource set mentioned in the embodiment of the disclosure may include multiple resources with a specific resource granularity, and each resource may have a resource index.

Here, the first resource selected by the first device may include at least one resource, and the second resource selected by the second device may include at least one resource.

In an embodiment, the first device may be a terminal device, and the second device may be a network device. The embodiment of the disclosure is not limited thereto. For example, both the first device and the second device may be terminal devices.

In an embodiment, the first channel and the second channel may be the same type of channel.

Here, the type may be divided according to uplink and downlink. For example, the first channel and the second channel are uplink channels, or the first channel and the second channel are downlink channels.

Or the type is divided according to uplink and downlink and in combination with a type of information transmitted through a channel. For example, the first channel and the second channel are PUSCHs, or the first channel and the second channel are PUCCHs, or the first channel and the second channel are PDSCHs.

Or the type is divided according to a type of information transmitted through a channel. For example, the first channel and the second channel are data channels, or the first channel and the second channel are control channels.

In an embodiment of the disclosure, the first channel is different from the second channel in terms of at least one of: a bandwidth part where the channel is located, a carrier where the channel is located, a cell where the channel is located, a duplex direction used for the channel, or a numerology used for the channel.

In an embodiment, the numerology used for the first channel is different from the numerology used for the second channel includes at least one of the following: a subcarrier spacing used for the first channel is different from a subcarrier spacing used for the second channel, or a cyclic prefix used for the first channel is different from a cyclic prefix used for the second channel.

For convenient understanding, how the first device determines, based on the first resource set, the second resource for the transmission of the second channel will be introduced below.

In an implementation mode, the first device may determine, from the first resource set, the second resource for the transmission of the second channel.

The first resource set may include multiple resources, each of the multiple resources may have its own index, and the first device may select, from the resource set, one or more resources for the transmission of the second channel.

Here, the second device may notify the first device of an index of a resource to be selected. For example, the second device notifies, through information carried in a PDCCH, the terminal device of an index of a resource for transmission of a PUCCH. Or the second device may not notify the terminal device of an index of a resource to be selected, but only transmit a triggering instruction that instructs the first device to transmit the second channel or receive the second channel, and the first device may select (for example, randomly selects), after receiving the triggering instruction, a resource from the resource set. Or the second device may transmit a downlink data channel to the first device, and the second device may select a resource for transmitting a feedback for the data channel.

In an embodiment, when the first device on its own selects resource(s) from the first resource set, the number of selected resources may be determined according to a volume of data currently to be transmitted.

In an implementation mode, the first device determines a second resource set based on the first resource set, and the first device determines, from the second resource set, the second resource for the transmission of the second channel between the first device and the second device.

The first device obtains the second resource set based on the first resource set, here, the second resource set may include multiple resources, each of the multiple resources has its own index, and the first device may select, from the second resource set, one or more resources for the transmission of the second channel.

Here, the second device may transmit second information to the first device, and the first device may select one or more resources from the second resource set according to the second information.

Here, the second information may indicate an index of a resource to be selected by the first device. For example, the second device notifies, through information carried in the PDCCH, the first device of information about a resource for transmission of the PUCCH. Or the second information is only a triggering instruction that triggers a terminal to select a resource from the second resource set. Or the second information may be carried in a downlink data channel, and the first device may select a resource for transmitting feedback information for the second information. Or the second information contains an index of a resource in the first resource set rather than an index of a resource to be selected by the first device from the second resource set, and the first device may deduce, according to a manner in which the second resource set is determined based on the first resource set, a resource index corresponding to the index contained in the second information, in the second resource set.

In an embodiment, when the first device on its own selects resource(s) from the first resource set, the number of selected resources may be determined according to a volume of data presently to be transmitted.

In an embodiment, a granularity of resources in the second resource set may be equal to a granularity of resources in the first resource set. In such case, if resources in the first resource set partially overlap with resources in the second resource set, indexes of overlapping resources may be retained, or indexes of all resources in the second resource set may be rearranged.

Or a granularity of resources in the second resource set may be not equal to a granularity of resources in the first resource set. For example, a resource with one granularity in the second resource set may be equal to resources with two granularities in the first resource set. The first device may reset new resources for the resources in the second resource set, so that each of the resources in the second resource set has a unique resource index distinguished from other resources in the second resource set.

Several manners for determining the second resource set will be introduced below.

In an implementation mode, the first device may determine a subset of the first resource set as the second resource set.

The first device may select a part of resources from the first resource set to form the second resource set.

Here, a granularity of resources in the second resource set may be equal to a granularity of resources in the first resource set, and in such case, the first device may determine indexes of resources to be selected and form the resources with these indexes into the second resource set. Indexes in the second resource set can still be the indexes in the first resource set. For example, if the indexes of the resources selected from the first resource set are 1, 3 and 5, the indexes of the resources in the second resource set may be 1, 3 and 5. Or resource indexes may be reset for the resources in the second resource set. For example, the indexes of the resources in the second resource set may be 1, 2 and 3.

Or a granularity of resources in the second resource set may be not equal to a granularity of resources in the first resource set. For example, resources with one granularity in the second resource set may be equal to resources with two granularities in the first resource set. In such case, the first device may determine indexes of resources to be selected from the first resource set and merge these resources in pairs to meet the granularity of resources in the second resource set. The first device may reset new resources for the resources in the second resource set, so that each of the resources in the second resource set has a unique resource index distinguished from the other resources in the second resource set.

In an embodiment, the second device may transmit third information to the first device, here, the third information is used to indicate the subset forming the second resource set. Therefore, the first device may determine the subset of the first resource set based on the third information and determine the subset as the second resource set. Furthermore, the second device may also instruct the first device how to set the indexes for the resources in the second resource set after the second resource set is formed.

Or a rule on how to select, from the first resource set, the subset used to form the second resource set may also be preset in the first device. Furthermore, a manner for setting the indexes of the resources in the second resource set may also be preset in the first device.

In another implementation mode, a resource is added into the first resource set to form the second resource set.

The first device may add a new resource into the resource set to form the second resource set.

Here, a granularity of resources in the second resource set may be equal to a granularity of resources in the first resource set. In such case, the first device may add, into the first resource set, a resource with the same granularity as the resources in the first resource set. Here, the first device may keep, in the second resource set, the original indexes of the resources in the first resource set unchanged and add a new index for the new resource, or the first device may reset new indexes for the resources in the second resource set.

Or a granularity of resources in the second resource set may be unequal to a granularity of resources in the first resource set, and in such case, the second device may reset a respective new index for each of the resources in the second resource set.

In an embodiment, the second device may transmit fourth information to the first device, here, the fourth information is used to indicate a resource to be added (i.e., new resource). Therefore, the first device may determine the resource to be added based on the fourth information and add the new resource into the first resource set to form the second resource set. Furthermore, the second device may also instruct the first device how to set the indexes for the resources in the second resource set after the second resource set is formed.

Or a rule on how to add a resource into the first resource set to form the second resource set may also be preset in the first device. Furthermore, a manner for setting the indexes of the resources in the second resource set may also be preset in the first device.

In another implementation mode, at least one of the number of resources in the first resource set or a granularity of resources in the first resource set is extended or reduced in at least one of a time domain or a frequency domain to form the second resource set.

The first device may extend or reduce the number of resources in the first resource set in the frequency domain or the time domain to form the second resource set. For example, the number of time-domain resources in the first resource set remains unchanged and the number of resources is increased or decreased on the basis of the original number of frequency-domain resources; or the number of frequency-domain resources in the first resource set remains unchanged and the number of resources is increased or decreased on the basis of the original number of time-domain resources in the first resource set.

Here, the second resource set obtained by extension of the number of resources may include the original resources in the first resource set, or may include a part of the original resources in the first resource set or include no resources in the first resource set. Or the second resource set obtained by reduction of the number of resources may be a subset of the first resource set, or may have partial intersection with the first resource set, or even have no intersection with the first resource set.

The first device may extend or reduce the granularity of resources in the first resource set in the frequency domain or the time domain to form the second resource set.

Here, a size of the granularity of resources in the first resource set remains unchanged in the time-domain, and frequency-domain resources are extended or reduced. For example, if the granularity of resources in the first resource set occupies M symbols in the time domain and occupies N subcarriers in the frequency domain, the granularity of resources in the second resource set occupies M symbols in the time domain and occupies N+b or aN subcarriers in the frequency domain. Or a size of the granularity of resources in the first resource set remains unchanged in the frequency-domain, and the size in time-domain is extended or reduced. For example, if the granularity of resources the first resource set occupies M symbols in the time domain and occupies N subcarriers in the frequency domain, the granularity of resources in the second resource set occupies M+c or dM symbols in the time domain and occupies N subcarriers in the frequency domain.

Of course, extension or reduction may also be performed in both the time domain and the frequency domain; or extension is performed in the time domain and reduction is performed in the frequency domain, or extension is performed in the frequency domain and reduction is performed in the time domain.

The resource granularity (i.e., the granularity of resources) is extended or reduced may include that a width of a subcarrier or a length of a symbol in resources forming the resource granularity is extended or reduced. For example, the number of symbols or subcarriers in each resource remains unchanged, but a length of a symbol or a width of a subcarrier is changed.

In an embodiment, positions of resources in the first resource set are the same as positions of resources in the second resource set; or the number of resources in the first resource set is the same as the number of resources in the second resource set; or positions of resources in the first resource set are the same as positions of resources in the second resource set and the number of resources in the first resource set is the same as the number of resources in the second resource set. The first resource set is different from the second resource set in terms of resource granularity. Or the first resource set is different from the second resource set in terms of not only resource granularity but also at least one of positions of resources or the number of resources.

In an embodiment, the second device may transmit fifth information to the first device, here, the fifth information is used to indicate an amplitude of extension or reduction for at least one of the number of resources in the first resource set or the granularity of resources in the first resource set. Furthermore, the second device may also instruct the first device how to set the indexes for the resources in the second resource set after the second resource set is formed.

Or the rule on how to select, from the first resource set, the subset for forming the second resource set may also be preset in the first device. Furthermore, the manner for setting the indexes of the resources in the second resource set may also be preset in the first device.

In an embodiment, the first device may determine, based on a frequency-domain magnitude relationship between a carrier where the first channel is located and a carrier where the second channel is located, an amplitude of extension or reduction for the at least one of the number of resources or the granularity of resources; or the first device may determine, based on a frequency-domain magnitude relationship between a bandwidth part where the first channel is located and a bandwidth part where the second channel is located, an amplitude of extension or reduction for the at least one of the number of resources or the granularity of resources.

The amplitude mentioned in the embodiment of the disclosure may be an absolute value, or may be a proportion.

In another implementation mode, the first resource set is offset in at least one of a time domain or a frequency domain to form the second resource set.

In the implementation mode, the number of resources in the first resource set may be equal to the number of resources in the second resource set. For example, if a time-domain starting position of the resources in the first resource set is a slot 1, an ending position is a slot 10 and an offset is two slots, a time-domain starting position of the resources in the second resource set is a slot 3 and an ending position is 12.

Or the number of resources in the first resource set may be unequal to the number of resources in the second resource set. For example, if a time-domain starting position of the resources in the first resource set is a slot 1, an ending position is a slot 10 and an offset is two slots, a time-domain starting position of the resources in the second resource set is a slot 3 and an ending position is a slot 10.

In an embodiment, the first device receives sixth information from the second device, here, the sixth information is used to indicate an offset. Furthermore, the second device may also instruct the first device how to set the indexes for the resources in the second resource set after the second resource set is formed.

Or a rule on how to perform an offset on the basis of the first resource set to form the second resource set may also be preset in the first device. Furthermore, the manner for setting the indexes of the resources in the second resource set may also be preset in the first device.

Although each of the several manners for determining the second resource set based on the first resource set are independently introduced above, these manners do not exist independently and these manners may be combined for use under some circumstances. For example, the second resource set may be formed by performing an extension or reduction on the granularity of resources in the first resource set and by performing an offset on the first resource set.

How to determine, based on the first resource set, the second resource for the transmission of the second channel has been introduced above, and how to determine, based on the first resource set, the resource for the transmission of the first channel will be introduced below.

In an implementation mode, the first device determines, from the first resource set, the first resource for the transmission of the first channel.

In an embodiment, the first device receives seventh information transmitted by the second device, and the first device determines the first resource from the first resource set according to the seventh information.

In an implementation mode, the first device determines a third resource set based on the first resource set, and the first device determines, from the third resource set, the first resource for the transmission of the first channel between the first device and the second device.

In an embodiment, the first device receives eighth information transmitted by the second device, and the first device determines the first resource from the third resource set according to the eighth information.

In an embodiment, the first device determines the third resource set based on the first resource set includes the following operation.

The third resource set is determined based on the first resource set in one of the following manners that: a subset of the first resource set is determined as the third resource set; a resource is added into the first resource set to form the third resource set; the number of resources or a granularity of resources in the first resource set is extended or reduced in at least one of a time domain or a frequency domain to form the third resource set; or the first resource set is offset in a time domain or a frequency domain to form the third resource set.

In an embodiment, the manner in which the third resource set is determined based on the first resource set is that the subset of the first resource set is determined as the third resource set; and the first device receives ninth information from the second device, here, the ninth information is used to indicate the subset.

In an embodiment, the manner in which the third resource set is determined based on the first resource set is that the resource is added into the first resource set to form the third resource set, and the first device receives tenth information from the second device, here, the tenth information is used to indicate a resource to be added.

In an embodiment, the manner in which the third resource set is determined based on the first resource set is that the number of resources or the granularity of resources in the first resource set is extended or reduced in the at least one of the time domain or the frequency domain to form the third resource set, and the first device receives eleventh information from the second device, here, the eleventh information is used to indicate an amplitude of extension or reduction.

In an embodiment, the manner in which the third resource set is determined based on the first resource set is that the number of resources or the granularity of resources in the first resource set is extended or reduced in the at least one of the time domain or the frequency domain to form the third resource set, and an amplitude of extension or reduction is determined based on a frequency-domain magnitude relationship between a carrier where the first channel is located and a carrier where the second channel is located or based on a frequency-domain magnitude relationship between a bandwidth part where the first channel is located and a bandwidth part where the second channel is located.

In an embodiment, the manner in which the third resource set is determined based on the first resource set is that the first resource set is offset in the time domain or the frequency domain to form the third resource set, and the first device receives twelfth information from the second device, here, the twelfth information is used to indicate an offset.

In an embodiment, the manner in which the third resource set is determined based on the first resource set is preset in the first device.

The implementation of some details about determination of the resource for transmission of the first channel based on the first resource set may refer to the implementation of determination of the resource for transmission of the second channel based on the first resource set and, for simplicity, elaborations are omitted herein.

Accordingly, in the embodiment of the disclosure, the second device configures the first resource set for the first device, the first device may transmit the first channel based on the first resource set, and the first device may also transmit the second channel based on the second resource set. Therefore, the problem of high signaling overhead caused by the case where the first device separately configure, for the second device, a resource set for the first channel and a resource set for the second channel may be solved, flexibility in configuration and use of resources may be achieved, and an association between transmission of the first channel and transmission of the second channel may be achieved.

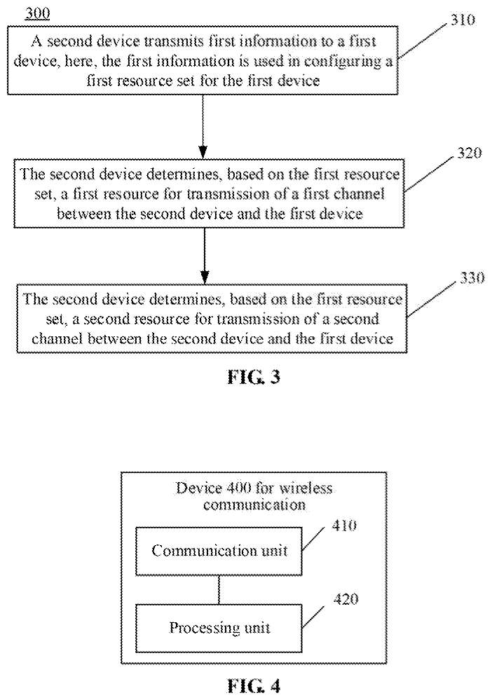

FIG. 3 is a flowchart of a method 300 for wireless communication according to an embodiment of the disclosure. The method 300 includes at least part of contents in the following contents.

In 310, a second device transmits first information to a first device, here, the first information is used in configuring a first resource set for the first device.

In 320, the second device determines, based on the first resource set, a first resource for transmission of a first channel between the second device and the first device.

In 330, the second device determines, based on the first resource set, a second resource for transmission of a second channel between the second device and the first device.

In an embodiment, the first channel is different from the second channel in terms of at least one of: a bandwidth part where the channel is located, a carrier where the channel is located, a cell where the channel is located, a duplex direction adopted for the channel, or a numerology adopted for the channel.

In an embodiment, that the numerology adopted for the first channel is different from the numerology adopted for the second channel includes at least one of the following: a subcarrier spacing adopted for the first channel is different from a subcarrier spacing adopted for the second channel, or a cyclic prefix adopted for the first channel is different from a cyclic prefix adopted for the second channel.

In an embodiment, the first channel and the second channel are the same type of channel.

In an embodiment, the second device determines a second resource set based on the first resource set, and the second device determines, from the second resource set, the second resource for the transmission of the second channel between the second device and the first device.

In an embodiment, the second device transmits second information to the first device for the first device to determine the first resource form the first resource set.

In an embodiment, the second resource set is determined based on the first resource set in one of the following manners that: a subset of the first resource set is determined as the second resource set; a resource is added into the first resource set to form the second resource set; the number of resources or a granularity of resources in the first resource set is extended or reduced in at least one of a time domain or a frequency domain to form the second resource set; or the first resource set is offset in a time domain or a frequency domain to form the second resource set.

In an embodiment, the manner in which the second resource set is determined based on the first resource set is that the subset of the first resource set is determined as the second resource set, and the method further includes the following operation.

The second device transmits third information to the first device, here, the third information is used to indicate the subset.

In an embodiment, the manner in which the second resource set is determined based on the first resource set is that the resource is added into the first resource set to form the second resource set, and the method further includes that the second device transmits fourth information to the first device, here, the fourth information is used to indicate a resource to be added.

In an embodiment, the manner in which the second resource set is determined based on the first resource set is that the number of resources or the granularity of resources in the first resource set is extended or reduced in the at least one of the time domain or the frequency domain to form the second resource set, and the method further includes the following operation.

The second device transmits fifth information to the first device, here, the fifth information is used to indicate an amplitude of extension or reduction.

In an embodiment, the manner in which the second resource set is determined based on the first resource set is that the number of resources or the granularity of resources in the first resource set is extended or reduced in the at least one of the time domain or the frequency domain to form the second resource set, and the method further includes the following operation.

An amplitude of extension or reduction is determined based on a frequency-domain magnitude relationship between a carrier where the first channel is located and a carrier where the second channel is located or based on a frequency-domain magnitude relationship between a bandwidth part where the first channel is located and a bandwidth part where the second channel is located.

In an embodiment, the manner in which the second resource set is determined based on the first resource set is that the first resource set is offset in the time domain or the frequency domain to form the second resource set, and the method further includes the following operation.

The second device transmits sixth information to the first device, here, the sixth information is used to indicate an offset.

In an embodiment, the operation that the second device determines, based on the first resource set, the first resource for the transmission of the first channel between the second device and the first device includes the following operation.

The second device determines, from the first resource set, the first resource for the transmission of the first channel.

In an embodiment, the second device transmits seventh information to the first device for the first device to determine the first resource from the first resource set.

In an embodiment, the second device determines a third resource set based on the first resource set.

The second device determines, from the third resource set, the first resource for the transmission of the first channel between the second device and the first device.

In an embodiment, the second device transmits eighth information to the first device for the first device to determine the first resource from the third resource set.

In an embodiment, the third resource set is determined based on the first resource set in one of the following manners that: a subset of the first resource set is determined as the third resource set; a resource is added into the first resource set to form the third resource set; the number of resources or a granularity of resources in the first resource set is extended or reduced in at least one of a time domain or a frequency domain to form the third resource set; or the first resource set is offset in a time domain or a frequency domain to form the third resource set.

In an embodiment, the manner in which the third resource set is determined based on the first resource set is that the subset of the first resource set is determined as the third resource set; and the second device transmits ninth information to the first device, here, the ninth information is used to indicate the subset.

In an embodiment, the manner in which the third resource set is determined based on the first resource set is that the resource is added into the first resource set to form the third resource set; and the second device transmits tenth information to the first device, here, the tenth information is used to indicate a resource to be added.

In an embodiment, the manner in which the third resource set is determined based on the first resource set is that the number of resources or the granularity of resources in the first resource set is extended or reduced in the at least one of the time domain or the frequency domain to form the third resource set; and the second device transmits eleventh information to the first device, here, the eleventh information is used to indicate an amplitude of extension or reduction.

In an embodiment, the manner in which the third resource set is determined based on the first resource set is that the number of resources or the granularity of resources in the first resource set is extended or reduce in the at least one of the time domain or the frequency domain to form the third resource set; and an amplitude of extension or reduction is determined based on a frequency-domain magnitude relationship between a carrier where the first channel is located and a carrier where the second channel is located or based on a frequency-domain magnitude relationship between a bandwidth part where the first channel is located and a bandwidth part where the second channel is located.

In an embodiment, the manner in which the third resource set is determined based on the first resource set is that the first resource set is offset in the time domain or the frequency domain to form the third resource set; and the second device transmits twelfth information to the first device, here, the twelfth information is used to indicate an offset.

The manners in which the second device determines the resource set and selects the resource from the resource set may refer to the manners in which the first device determines the resource set and selects the resource from the resource set illustrated in the method 200 and, for simplicity, elaborations are omitted herein.

Accordingly, in the embodiment of the disclosure, the second device configures the first resource set for the first device, the first device may transmit the first channel based on the first resource set, and the first device may also transmit the second channel based on the second resource set. Therefore, the problem of high signaling overhead brought by the case where the first device separately configures, for the second device, a resource set for the first channel and a resource set for the second channel may be solved, flexibility in configuration and use of resources may be achieved, and an association between transmission of the first channel and transmission of the second channel may be achieved.

FIG. 4 is a block diagram of a device 400 for wireless communication according to an embodiment of the disclosure. As illustrated in FIG. 4, the device 400 includes a communication unit 410 and a processing unit 420.

The communication unit 410 is configured to receive first information transmitted by a second device, here, the first information is used in configuring a first resource set for a first device.

The processing unit 420 is configured to determine, based on the first resource set, a first resource for transmission of a first channel between the first device and the second device and determine, based on the first resource set, a second resource for transmission of a second channel between the first device and the second device.

The device 400 for wireless communication may correspond to the first device in the method embodiments, may implement corresponding operations implemented by the first device in the method embodiments and, for simplicity, will not be elaborated herein.

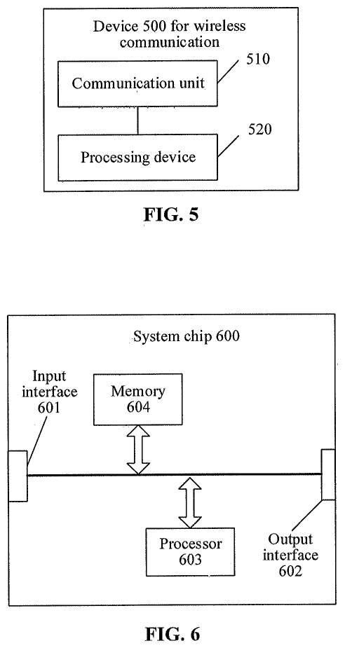

FIG. 5 is a block diagram of a device 500) for wireless communication according to an embodiment of the disclosure. As illustrated in FIG. 5, the network device 500 includes a communication unit 510 and a processing unit 520.

The communication unit 510 is configured to transmit first information to a first device, here, the first information is used in configuring a first resource set for the first device.

The processing unit 520 is configured to determine, based on the first resource set, a first resource for transmission of a first channel between the device and the first device and determine, based on the first resource set, a second resource for transmission of a second channel between the device and the first device.

The device 500 may correspond to the second device in the method embodiments, may implement corresponding operations implemented by the second device in the method embodiments and, for simplicity, will not be elaborated herein.

FIG. 6 is a structure diagram of a system chip 600 according to an embodiment of the disclosure. The system chip 600 of FIG. 6 includes an input interface 601, output interface 602, processor 603 and memory 604 which may be connected through an internal communication connection line. The processor 603 is configured to execute a code in the memory 604.

In an embodiment, when the code is executed, the processor 603 implements the method executed by the first device in the method embodiments. For simplicity, elaborations are omitted herein.

In an embodiment, when the code is executed, the processor 603 implements the method executed by the second device in the method embodiments. For simplicity, elaborations are omitted herein.

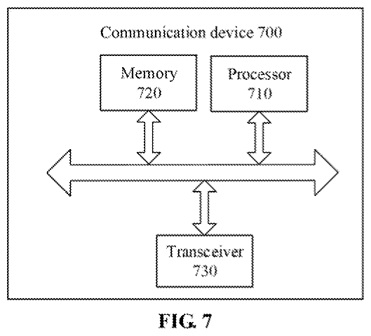

FIG. 7 is a block diagram of a communication device 700 according to an embodiment of the disclosure. As illustrated in FIG. 7, the communication device 700 includes a processor 710 and a memory 720. Herein, the memory 720 may store a program code, and the processor 710 may execute the program code stored in the memory 720.

In an embodiment, as illustrated in FIG. 7, the communication device 700 may include a transceiver 730, and the processor 710 may control the transceiver 730 for external communication.

In an embodiment, the processor 710 may call the program code stored in the memory 720 to execute corresponding operations of the first device in the method embodiments. For similarity, elaborations are omitted herein.

In an embodiment, the processor 710 may call the program code stored in the memory 720 to execute corresponding operations of the second device in the method embodiments. For similarity, elaborations are omitted herein.

The processor in the embodiments of the disclosure may be an integrated circuit chip and has a signal processing capability. In an implementation process, each operation of the method embodiments may be completed by an integrated logical circuit of hardware in the processor or an instruction in a software form. The processor may be a universal processor, a Digital Signal Processor (DSP), an Application Specific Integrated Circuit (ASIC), a Field Programmable Gate Array (FPGA) or another programmable logical device, discrete gate or transistor logical device and discrete hardware component. Each method, operation and logical block diagram disclosed in the embodiments of the disclosure may be implemented or executed. The universal processor may be a microprocessor or the processor may also be any conventional processor and the like. The operations of the methods disclosed in combination with the embodiments of the disclosure may be directly embodied to be executed and completed by a hardware decoding processor or executed and completed by a combination of hardware and software modules in the decoding processor. The software module may be located in a mature storage medium in this field such as a Random Access Memory (RAM), a flash memory, a Read-Only Memory (ROM), a Programmable ROM (PROM) or Electrically Erasable PROM (EEPROM) and a register. The storage medium is located in a memory, and the processor reads information in the memory and completes the operations of the methods in combination with hardware.

The memory in the embodiments of the disclosure may be a volatile memory or a nonvolatile memory, or may include both the volatile and nonvolatile memories. The nonvolatile memory may be a ROM, a PROM, an Erasable PROM (EPROM), an EEPROM or a flash memory. The volatile memory may be a RAM, and is used as an external high-speed cache. It is exemplarily but unlimitedly described that RAMs in various forms may be adopted, such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM) and a Direct Rambus RAM (DR RAM). The memory of a system and method described in the disclosure is intended to include, but not limited to, memories of these and any other proper types.

Those of ordinary skill in the art may realize that the units and algorithm operations of each example described in combination with the embodiments disclosed in the disclosure may be implemented by electronic hardware or a combination of computer software and the electronic hardware. Whether these functions are executed in a hardware or software manner depends on specific applications and design constraints of the technical solutions. Professionals may realize the described functions for each specific application by use of different methods, but such realization shall fall within the scope of the disclosure.

Those skilled in the art may clearly learn about that specific working process of the system, device and unit described above may refer to the corresponding processes in the method embodiments and will not be elaborated herein for convenient and brief description.

In some embodiments provided by the disclosure, the disclosed system, device and method may be implemented in another manner. For example, the device embodiments described above is only schematic, and for example, division of the units is only logic function division, and other division manners may be adopted during practical implementation. For example, multiple units or components may be combined or integrated into another system, or some characteristics may be neglected or not executed. In addition, mutual coupling or direct coupling or communication connection between displayed or discussed components may be indirect coupling or communication connection of the device or the units through some interfaces, and may be electrical and mechanical or adopt other forms.

The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, each functional unit in each embodiment of the disclosure may be integrated into a processing unit, each unit may also physically exist independently, or two or more than two units may also be integrated into a unit.

When being realized in form of software functional unit and sold or used as an independent product, the function may also be stored in a computer-readable storage medium. Based on such an understanding, the technical solutions of the disclosure substantially or parts making contributions to the related art or part of the technical solutions may be embodied in form of software product, and the computer software product is stored in a storage medium, and includes a plurality of instructions configured to enable a computer device (which may be a personal computer, a server, a network device or the like) to execute all or part of the operations of the method in each embodiment of the disclosure. The abovementioned storage medium includes various media capable of storing program codes, such as a U disk, a mobile hard disk, a ROM, a RAM, a magnetic disk or an optical disk.

The above is only the specific implementation mode of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. A method for wireless communication, comprising:
receiving, by a first device, first information transmitted by a second device, wherein the first information is used in configuring a first resource set for the first device;
determining, by the first device, based on the first resource set, a first resource for transmission of a first channel between the first device and the second device; and
determining, by the first device, based on the first resource set, a second resource for transmission of a second channel between the first device and the second device.

2. The method of claim 1, wherein the first channel is different from the second channel in terms of at least one of:
a bandwidth part where the channel is located, a carrier where the channel is located, a cell where the channel is located, a duplex direction adopted for the channel, or a numerology adopted for the channel.

3. The method of claim 2, wherein the numerology adopted for the first channel is different from the numerology adopted for the second channel comprises at least one of: a subcarrier spacing adopted for the first channel is different from a subcarrier spacing adopted for the second channel, or a cyclic prefix adopted for the first channel is different from a cyclic prefix adopted for the second channel.

4. (canceled)

5. The method of claim 1, wherein determining, by the first device, the second resource for the transmission of the second channel between the first device and the second device based on the first resource set comprises:
determining, by the first device, a second resource set based on the first resource set; and
determining, by the first device, from the second resource set, the second resource for the transmission of the second channel between the first device and the second device.

6. (canceled)

7. The method of claim 5, wherein determining, by the first device, the second resource set based on the first resource set comprises:
determining the second resource set based on the first resource set in one of the following manners that:
a subset of the first resource set is determined as the second resource set;
a resource is added into the first resource set to form the second resource set;
a number of resources in the first resource set or a granularity of resources in the first resource set is extended or reduced in at least one of a time domain or a frequency domain to form the second resource set; or
the first resource set is offset in a time domain or a frequency domain to form the second resource set.

8. (canceled)

9. The method of claim 7, wherein the manner in which the second resource set is determined based on the first resource set comprises that the resource is added into the first resource set to form the second resource set; and
the method further comprises:
receiving, by the first device, fourth information from the second device, wherein the fourth information is used to indicate a resource to be added;
or,
the manner in which the second resource set is determined based on the first resource set comprises that the number of resources in the first resource set or the granularity of resources in the first resource set is extended or reduced in the at least one of the time domain or the frequency domain to form the second resource set; and
the method further comprises:
receiving, by the first device, fifth information from the second device, wherein the fifth information is used to indicate an amplitude of extension or reduction;
or,
the manner in which the second resource set is determined based on the first resource set comprises that the number of resources in the first resource set or the granularity of resources in the first resource set is extended or reduced in the at least one of the time domain or the frequency domain to form the second resource set; and
the method further comprises:
determining an amplitude of extension or reduction based on a frequency-domain magnitude relationship between a carrier where the first channel is located and a carrier where the second channel is located or based on a frequency-domain magnitude relationship between a bandwidth part where the first channel is located and a bandwidth part where the second channel is located;
or,
the manner in which the second resource set is determined based on the first resource set comprises that the first resource set is offset in the time domain or the frequency domain to form the second resource set; and
the method further comprises:
receiving, by the first device, sixth information from the second device, wherein the sixth information is used to indicate an offset.

10.-15. (canceled)

16. The method of claim 1, wherein determining, by the first device, the first resource for the transmission of the first channel between the first device and the second device based on the first resource set comprises:
determining, by the first device, a third resource set based on the first resource set; and
determining, by the first device, from the third resource set, the first resource for the transmission of the first channel between the first device and the second device.

17. (canceled)

18. The method of claim 16, wherein determining, by the first device, the third resource set based on the first resource set comprises:
determining the third resource set based on the first resource set in one of the following manners that:
a subset of the first resource set is determined as the third resource set;
a resource is added into the first resource set to form the third resource set;
a number of resources in the first resource set or a granularity of resources in the first resource set is extended or reduced in at least one of a time domain or a frequency domain to form the third resource set; or
the first resource set is offset in a time domain or a frequency domain to form the third resource set.

19.-47. (canceled)

48. A device for wireless communication, the device being a first device and comprising a transceiver and a processor wherein
the transceiver is configured to receive first information transmitted by a second device, wherein the first information is used in configuring a first resource set for the first device; and
the processor is configured to determine, based on the first resource set, a first resource for transmission of a first channel between the first device and the second device and determine, based on the first resource set, a second resource for transmission of a second channel between the first device and the second device.

49. The device of claim 48, wherein the first channel is different from the second channel in terms of at least one of:
a bandwidth part where the channel is located, a carrier where the channel is located, a cell where the channel is located, a duplex direction adopted for the channel, or a numerology adopted for the channel.

50. The device of claim 49, wherein the numerology adopted for the first channel is different from the numerology adopted for the second channel comprises at least one of: a subcarrier spacing adopted for the first channel is different from a subcarrier spacing adopted for the second channel, or a cyclic prefix adopted for the first channel is different from a cyclic prefix adopted for the second channel.

51. (canceled)

52. The device of claim 48, wherein the processor is further configured to:
determine a second resource set based on the first resource set; and
determine, from the second resource set, the second resource for the transmission of the second channel between the first device and the second device.

53. (canceled)

54. The device of claim 52, wherein the processor is further configured to:
determine the second resource set based on the first resource set in one of the following manners that:
a subset of the first resource set is determined as the second resource set;
a resource is added into the first resource set to form the second resource set;
a number of resources or a granularity of resources in the first resource set is extended or reduced in at least one of a time domain or a frequency domain to form the second resource set; or
the first resource set is offset in a time domain or a frequency domain to form the second resource set.

55. (canceled)

56. The device of claim 54, wherein the manner in which the second resource set is determined based on the first resource set comprises that the resource is added into the first resource set to form the second resource set; and
the transceiver is further configured to receive fourth information from the second device, wherein the fourth information is used to indicate a resource to be added.

57. The device of claim 54, wherein the manner in which the second resource set is determined based on the first resource set comprises that the number of resources or the granularity of resources in the first resource set is extended or reduced in the at least one of the time domain or the frequency domain to form the second resource set; and
the transceiver is further configured to receive fifth information from the second device, wherein the fifth information is used to indicate an amplitude of extension or reduction.

58. The device of claim 54, wherein the manner in which the second resource set is determined based on the first resource set comprises that the number of resources or the granularity of resources in the first resource set is extended or reduced in the at least one of the time domain or the frequency domain to form the second resource set; and
the processor is further configured to determine an amplitude of extension or reduction based on a frequency-domain magnitude relationship between a carrier where the first channel is located and a carrier where the second channel is located or based on a frequency-domain magnitude relationship between a bandwidth part where the first channel is located and a bandwidth part where the second channel is located.

59. The device of claim 54, wherein the manner in which the second resource set is determined based on the first resource set comprises that the first resource set is offset in the time domain or the frequency domain to form the second resource set; and
the transceiver is further configured to receive sixth information from the second device, wherein the sixth information is used to indicate an offset.

60.-62. (canceled)

63. The device of claim 48, wherein the processor is further configured to:
determine a third resource set based on the first resource set; and
determine, from the third resource set, the first resource for the transmission of the first channel between the first device and the second device.

64. (canceled)

65. The device of claim 63, wherein the processor is further configured to:
determine the third resource set based on the first resource set in one of the following manners that:
a subset of the first resource set is determined as the third resource set;
a resource is added into the first resource set to form the third resource set;
a number of resources or a granularity of resources in the first resource set is extended or reduced in at least one of a time domain or a frequency domain to form the third resource set; or
the first resource set is offset in a time domain or a frequency domain to form the third resource set.

66.-71. (canceled)

72. The device of claim 48, wherein the first device comprises a terminal device and the second device comprises a base station device.

73.-94. (canceled)
